(19) United States
(12) Patent Application Publication
(10) Pub. No.: US 2003/0066380 A1
(43) Pub. Date: Apr. 10, 2003

(54) Adjustable steering assembly for an electric scooter

(76) Inventor: Chen-Tai Cheng, Taichung (TW)

Correspondence Address: PEARNE & GORDON LLP, 526 SUPERIOR AVENUE EAST, SUITE 1200, CLEVELAND, OH, 44114-1484, US

(21) Appl. No.: 09/974,453

(22) Filed: Oct. 9, 2001

(51) Int. Cl. G05G 1/10

(52) U.S. Cl. 74/556

(57) ABSTRACT

A steering assembly for an electric scooter has a base, a steering bar, a positioning device and a lever. The steering bar is pivotally attached to the base. The positioning device is pivotally connected between the steering bar and the base to keep the front steering bar from pivoting relative to the base. The lever is connected to the positioning device with a cable to release the positioning device from the locked position. Consequently, the positioning device can be released from the locked position by means of pivoting the lever. The handle can be adjusted to a desired position for different users. The use of the steering assembly is more versatile. In addition, the steering assembly can be positioned at any desired position when the user pulls the lever. To adjust the steering assembly is more convenient.

### BACKGROUND OF THE INVENTION

1. Field of the Invention

The present invention relates to a steering assembly, and more particularly to an adjustable steering assembly for an electric scooter, which can be conveniently adjusted.

2. Description of Related Art

An electric scooter is used to help a person to move from place to place. The conventional electric scooter substantially comprises a body, at least one front wheel, two rear wheels, a seat, an electric motor and a steering assembly. Each front wheel is rotatably mounted on the front end of the body. Each rear wheel is rotatably mounted on the rear end of the body. The seat is mounted on the body for a user to sit. The electric motor is mounted on the body to drive the rear wheels. Consequently, the scooter can move at a slow speed and move the user to a desired location. The steering assembly includes a steering bar that is pivotally mounted on the front end of the body and is connected to each front wheel. Accordingly, the user can control the direction of the electric scooter by means of pivotally rotating the steering bar relative to the body. A headlight is secured on the steering bar so the electric scooter can be driven in the dark.

However, the steering bar of the conventional electric scooter is not designed to be able to pivot relative to the base. The position of the handle on the bar cannot be adjusted for different users. The use of the conventional electric scooter is not versatile.

To overcome the shortcomings, the present invention tends to provide an improved steering assembly to mitigate or obviate the aforementioned problems.

### SUMMARY OF THE INVENTION

The main objective of the invention is to provide an improved steering assembly for an electric scooter, which can be adjusted conveniently. The steering assembly has a base, a steering bar, a positioning device and a lever. The steering bar is pivotally attached to the top of the base and extends upward from the base. A handle is attached perpendicular to the top of the steering bar. The positioning device is pivotally connected between the steering bar and the base to keep the front steering bar from pivoting relative to the base. The lever is connected to the positioning device with a cable to release the positioning device from the locked position. With such an arrangement, the positioning device can be released from the locked position by means of pivoting the lever. The steering bar can pivot relative to the base, and the handle can be adjusted to a desired position for different users. The use of the steering assembly is more versatile. In addition, the lever can be positioned at any desired position where the user can pull the lever conveniently. To adjust the steering assembly is more convenient. Other objects, advantages and novel features of the invention will become more apparent from the following detailed description when taken in conjunction with the accompanying drawings.

### BRIEF DESCRIPTION OF THE DRAWINGS

FIG. 1 is a perspective view of a steering assembly in accordance with the present invention;

FIG. 2 is a side plan view of the steering assembly in FIG. 1;

FIG. 3 is an enlarged top plan view of the positioning device and the cable of the steering assembly in FIG. 1; and FIG. 4 is an operational side plan view of the steering assembly in FIG. 1 showing that the position of the steering assembly is adjusted.

### DETAILED DESCRIPTION OF PREFERRED EMBODIMENT

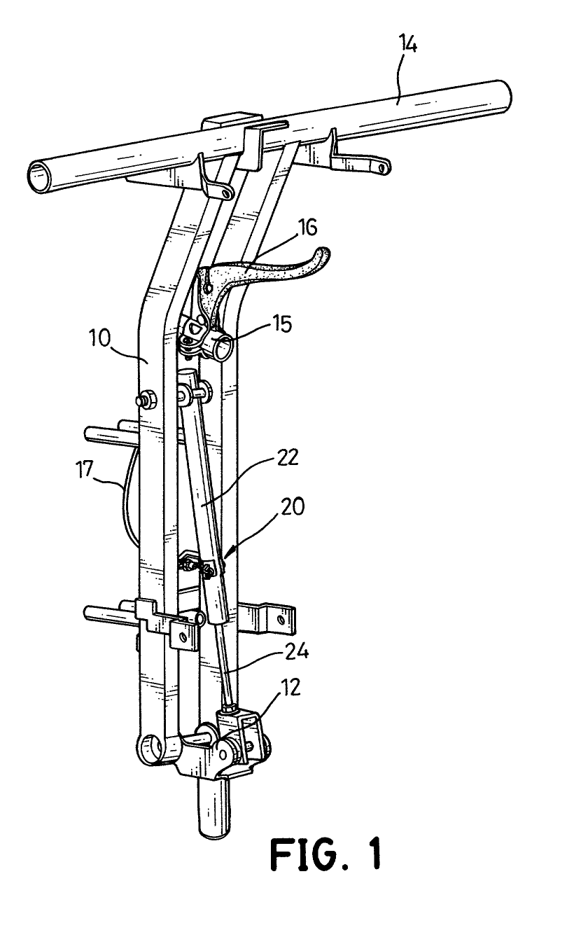

With reference to FIGS. 1 to 3, a steering assembly for an electric scooter in accordance with the present invention comprises a base (12), a steering bar (10), a handle (14) and a positioning device (20). The base (12) is rotatably attached to the body (not shown) of the electric scooter and is indirectly connected to the front wheel (not shown) of the scooter through a suspension linkage (not shown). The steering bar (10) is pivotally attached to the top of the base (12) and extends upward from the base (12). The handle (14) is attached perpendicular to the top of the steering bar (10).

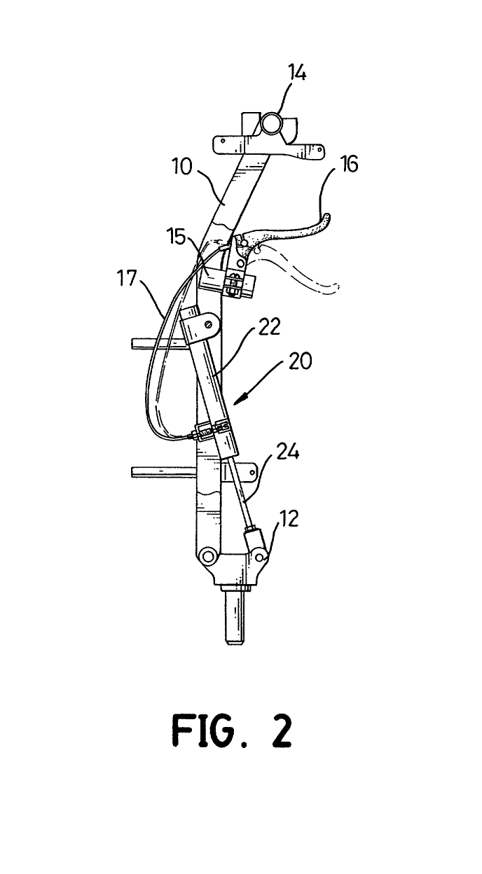

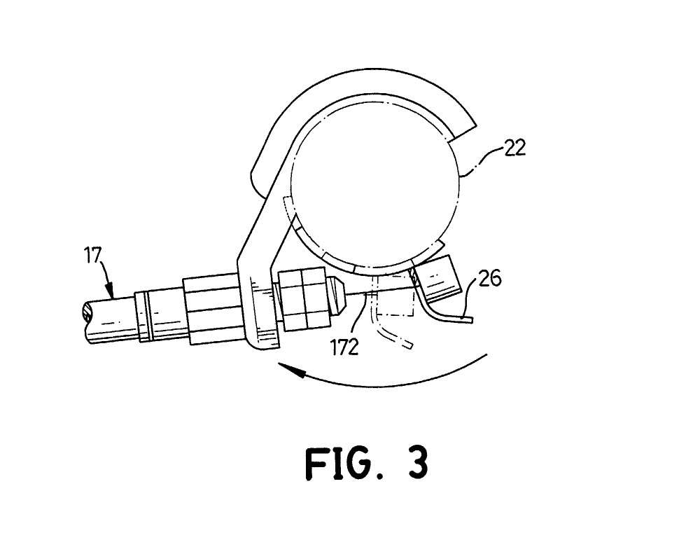

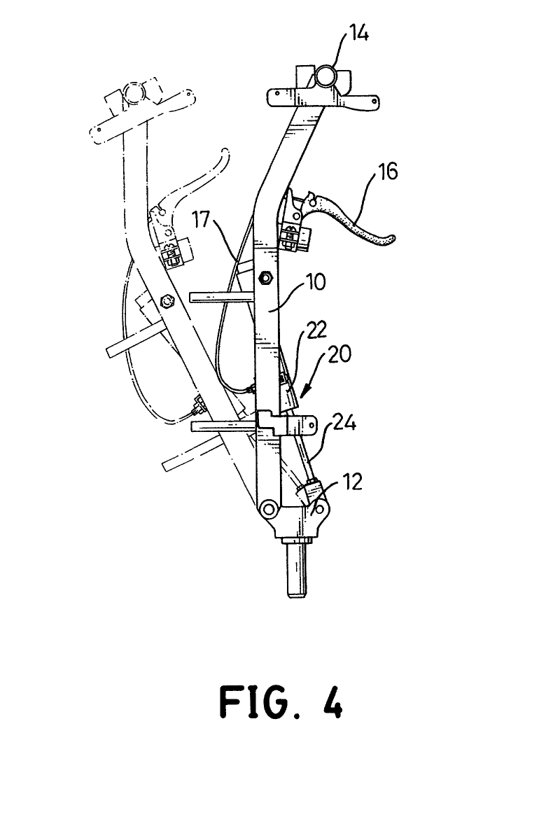

The positioning device (20) is pivotally mounted between the steering bar (10) and the base (12) to keep the steering bar (10) from pivoting relative to the base (12). The positioning device (20) includes a first tube (22), a second tube (24) and a positioning element. The first tube (22) and the second tube (24) have two ends (not numbered). One end of the first tube (22) is connected to the steering bar (10). One end of the second tube (24) is connected to the base (10), and the other end of the second tube (24) is slidably mounted into the end of the first tube (22) not connected to the steering bar (10). The positioning element (not shown) is mounted on the first tube (22) to stop the second tube (24) from sliding relative to the first tube (22), such that the position between the steering bar (10) and the base (12) is maintained. Consequently, the steering bar (10) will not pivot relative to the base (12) by means of the positioning effect provided by the positioning device (20). With reference to FIGS. 2 and 3, a tab (26) is moveable mounted on the first tube (22) and connected to the positioning element. When the tab (26) is moved relative to the first tube (22), the positioning element will be released the locked position. A biasing member (not shown) is mounted in the first tube (22) and abuts the tab (26) to provide a biasing force on the tab (26). Consequently, the tab (26) can be kept in the position to keep the positioning element locked.

In addition, a stand (15) is attached to the steering bar (12) near the handle (14). A lever (16) is pivotally attached to the stand (15). A cable (17) is connected between the lever (16) and the tab (26) on the positioning device (20). In practice, the cable (17) has a wire (172) with one end securely connected to the lever (16), and the other end of the wire (172) is securely connected to the tab (26) on the positioning device (20).

With reference to FIGS. 2 to 4, when the lever (16) is pivoted relative to the stand (15), the lever (16) will pull the tab (26) relative to the first tube (20) by means of the wire (172). Accordingly, the positioning element of the positioning device (20) will be released, and the second tube (24) can slide along the first tube (22). The steering bar (10) can pivot relative to the base (12). Consequently, the steering assembly can pivot relative to the body of the electric scooter. The handle (14) can be adjusted to be close or be far from the user sitting on the seat of the electric scooter.

When the handle (14) is at a desired position, the user releases the lever (16). The tab (26) will move relative to the first tube by the restoration force provided by the biasing member to the position where the positioning element is locked. The steering bar (10) is held relative to the base (12) again, and the handle (21) is positioned to a desired position for different users. The use of the steering assembly is more versatile. In addition, because to release the positioning device (20) from the locked position is controlled by the lever (16) and through the cable (17), the lever (16) can be positioned on any desired position where the user can pull the lever (16) conveniently. To adjust the steering assembly is more convenient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adjustable steering assembly for an electric scooter comprising:
a base adapted to be connected to a front wheel of the electric scooter;
a steering bar pivotally attached to a top of the base and extending upward from the base;
a handle attached perpendicular to a top of the steering bar;
a positioning device pivotally connected between the steering bar and the base to keep the front steering bar from pivoting relative to the base; and
a lever connected to the positioning device with a cable to release the positioning device from a locked position,
wherein the positioning device has:
a first tube with one end pivotally connected to the steering bar;
a second tube with one end pivotally connected to the base and the opposite end slidably inserted into the first tube; and
a positioning element mounted on the first tube and connected to the cable to keep the second tube from sliding relative to the first tube so as to keep the steering bar from pivoting relative to the base.

2. The steering assembly as claimed in claim 1, wherein the positioning element has a tab moveably mounted on the first tube and connected to the wire; and
a biasing member mounted in the first tube and abutting the tab to provide a biasing force on the tab to keep the tab in a position where the positioning element is locked.

3. The steering assembly as claimed in claim 1, wherein the lever is pivotally attached to the steering bar near the handle.

4. The steering assembly as claimed in claim 1 further comprises a stand secured to the steering bar to pivotally attach the lever to the stand.
